(19) United States
(12) Patent Application Publication
(10) Pub. No.: US 2020/0341903 A1
(43) Pub. Date: Oct. 29, 2020

(54) DATA CACHING, DYNAMIC CODE GENERATION, AND DATA VISUALIZATION TECHNOLOGY

(71) Applicant: Dove Ventures, LLC, Palmetto, FL (US)

(72) Inventor: Norman R. Dobiesz, Palmetto, FL (US)

(21) Appl. No.: 16/855,160

(22) Filed: Apr. 22, 2020

Related U.S. Application Data
(60) Provisional application No. 62/837,642, filed on Apr. 23, 2019.

(51) Int. Cl. G06F 12/0893; G06F 9/54

(52) U.S. Cl. CPC G06F 12/0893; G06F 2212/1041; G06F 9/541

(57) ABSTRACT

Techniques for data visualization, in which a template is defined that includes one or more drill paths for data visualization and dynamic code generation is performed to build at least one stored procedure for the one or more drill paths. The dynamic code generation includes generating dynamic code used to calculate data metric fields for the one or more drill paths included in the defined template. The data visualization includes importing, based on user input, the defined template, and the at least one stored procedure, source data that is needed to calculate the data metric fields using the generated dynamic code and caching, in a cache and based on the generated dynamic code, the imported source data and the data metric fields calculated using the generated dynamic code. At least one data structure is generated as data visualization output for one or more user devices based on the cache data.

### CROSS-REFERENCE TO RELATED APPLICATION

This application claims the benefit of U.S. Provisional Application No. 62/837,642, filed Apr. 23, 2019, and titled “Data Caching, Dynamic Code Generation, and Data Visualization Technology,” which is incorporated by reference.

### FIELD

Techniques are described for data caching, dynamic code generation, and/or data visualization of relatively large sets of data.

### BACKGROUND

Data visualization is the presentation of data in a pictorial or graphical format, and involves the creation and study of the visual representation of data. Data visualization enables end users to see data analytics presented visually, so the users can grasp difficult concepts or identify new patterns.

### SUMMARY

In some aspects, the subject matter of the present disclosure covers a method for data visualization comprising: defining a template that includes one or more drill paths for data visualization; performing dynamic code generation to build at least one stored procedure for the one or more drill paths, the dynamic code generation comprising generating dynamic code used to calculate data metric fields for the one or more drill paths included in the defined template; importing, based on user input, the defined template, and the at least one stored procedure, source data that is needed to calculate the data metric fields using the generated dynamic code; caching, in a cache and based on the generated dynamic code, the imported source data and the data metric fields calculated using the generated dynamic code; and generating, based on the cache data, at least one data structure as data visualization output for one or more user devices, the at least one data structure enabling data visualization of the one or more drill paths included in the defined template.

Implementations of the data visualization may include one or more of the following features. For example, in some implementations, the method further comprises: gaining, through a user interface application-programming interface (API), source data access; and ingesting, using the user interface API, the source data directly into a workspace for review, wherein the user interface API relates to a library for data processing and enables a data visualization output to the one or more user devices. In some implementations, the importing of the source data comprises: storing the source data to a database; modifying the stored source data to a form used for data processing by other users or applications; and registering and monitoring the one or more user devices for data security of the stored source data.

In some implementations, the one or more drill paths refer to data pathways through the source data, the source data is broken into groups, rows that constitute each of the groups, and fields that display within each of the rows, and the at least one data structure specifies a label, a format, and whether the source data appears at any level of the one or more drill paths or only a most drilled down level of the one or more drill paths. In some implementations, the method further comprises: defining reference data in the database; and sending instructions to the database through the user interface API, wherein one data metric field is selected from the source data for a specific data processing objective based on the instructions sent to the database through the user interface API. In some implementations, the data caching comprises: narrowing the imported source data to cache data stored in the cache, the imported source data has a larger size than the cache data stored in the cache; selecting the template to define data filtering and data format rearranging information; defining disparate data hierarchies by using the one or more drill paths, wherein each of the one or more drill paths defines a hierarchy of data; receiving source data information to determine source data layout and the generated dynamic code used for caching; and building, based on the at least one stored procedure and by using a data management function, the cache. In some implementations, the hierarchy of data is in a format of a data tree and includes source data group nodes that correspond to the one or more drill paths. In some implementations, one or more caches are stored in the cache, the cache storing data in form of metric fields, and the cache is a remote database.

In some implementations, the dynamic code generation comprises: identifying the source data for the data visualization; calculating, based on the identified source data and at least one stored procedure, the data metric fields; determining data grouping policy; and creating, based on the calculated data metric fields and determined data grouping policy, dynamic code to build cache data. In some implementations, the source data information comprises data source, metric fields, drill path for hierarchy, and groupby statements. In some implementations, based on narrowed down source data, the metric fields are calculated from at least one of a summarize calculation, a mean calculation, a median calculation, a minimum calculation, or a maximum calculation.

In some implementations, the method further comprises: processing a plurality of caches respectively for the one or more drill paths; sharing the data visualization output among the one or more user devices; and presenting, by a graphic data tool, visualization data in multiple levels that drill down from a summary level. In some implementations, the method further comprises: combining multiple data visualization outputs into one customized visualization view that leverages a visual navigation; and rendering a dashboard illustrating trends across pre-selected datasets by using underlying cached datasets. In some implementations, the method further comprises: rebuilding, based on template adjustment, the template for a preview in the data visualization output; and template rebuild validation including: initializing a rebuild model of the template; receiving a list of enabled structures of the template; receiving a list of a plurality of fields including source and metric fields, structure fields of the rebuild model, direct reference fields to the rebuild model, and parent reference fields to the rebuild model; and serialize the rebuild model to JSON objects to compute a new hash for the template.

In some implementations, the template rebuild is determined based on a comparison of hash values that are generated from the template adjustment and that are stored over time. In some implementations, based on the hash values generated from the template adjustment matching the hash values stored in the template, providing the data visualization output to show a preview without rebuilding the template or generating the cache, and based on the hash values generated from the template adjustment being different from the hash values stored in the template, rebuilding the template before the preview by regenerating at least one stored procedure and the cache. In some implementations, the template adjustment includes: changing of data source including changing a name of a field that is being used elsewhere, changing a datatype when the field is used elsewhere, changing an expression for calculated column values used in the template, and changing a summary value for the calculated column values used in the template; and changing of appearance of the source data in the data visualization output including a color, a size, a sort, a grid, a scorecard, or a dashboard. In some implementations, the method further comprises: verifying, by a validation API, user input to avoid issues involved in designing the template, generating the dynamic code, and building the cache; and performing, by a user interface tool, a visualization of the source data and the calculated metric fields using the at least one data structure.

The details of one or more implementations are set forth in the accompanying drawings and the description below. Other aspects, features and advantages will be apparent from the description, the drawings, and the claims.

### BRIEF DESCRIPTION OF THE DRAWINGS

FIG. 1 is a block diagram illustrating an example data visualization system.

FIG. 2 is a block diagram illustrating example data caching operations in an example data visualization system.

FIG. 3 is a flow chart illustrating an example process of data visualization operations.

FIG. 4 is a flow chart illustrating an example process for data caching.

FIG. 5 is a flow chart illustrating an example process of dynamic code generation.

FIG. 6 is a flow chart illustrating an example process of template rebuild validation.

FIG. 7 is a flow chart illustrating an example process of enhanced template validation.

FIG. 8 illustrates an example of an advanced designer module for dynamically defining a data visualization.

FIG. 9 illustrates an example of a graphic data tool that allows users to view data in multiple levels deeper from a summary level.

FIG. 10 illustrates an example of a dynamically created customizable callout feature.

FIG. 11 illustrates an example of viewing and exporting a node's data.

FIG. 12 illustrates an example of one or more underlying proprietary cached datasets to render a dashboard illustration of one or more trends.

FIG. 13 illustrates an example of a bookmark for data visualization.

FIGS. 14a and 14b illustrate an example of a general tab for data visualization.

FIG. 15 illustrates an example of software code that is stored in a remote database and used to modify attributes of data source fields.

FIG. 16 illustrates an example of software code that is stored in a remote database and used to dynamically generate a metric field.

FIGS. 17a and 17b illustrate an example of a drill path tab for data visualization.

FIGS. 18a and 18b illustrate an example of a color tab for data visualization.

FIGS. 19a and 19b illustrate an example of a size tab for data visualization.

FIGS. 20a and 20b illustrate an example of a sort tab for data visualization.

FIGS. 21a and 21b illustrate an example of a grid tab for data visualization.

FIGS. 22a and 22b illustrate an example of a scorecard tab for data visualization.

FIGS. 23a, 23b, and 23c illustrate an example of a detail view tab for data visualization.

### DETAILED DESCRIPTION

Data visualization allows a user to view information about data stored in a database along different dimensions in a database system. The data visualizations that are created to display the information can take on various forms. One typical form is that of a table layout, with each row representing a record in the database and each column representing a field from the record. The table usually lists a subset of the database records and a subset of the available fields in the database records.

Existing data visualization systems provide views that are often restricted to list or table-like structures with possible sorting, categorization or outlining features. Other data visualization systems use non-list type structures, but are restricted to views based upon intermediary data gathered from the database, not the actual database records themselves. With these systems, users may find it difficult to dynamically define the information to be visually displayed.

In some implementations, the present disclosure relates to management of a cache in a data visualization system to allow a user to create or modify a template for data processing. The data visualization system also allows the user to set labels and rules that dynamically drive the creation of code used to build the underlying cache and render the visualization of the data. With these techniques, the data visualization system may provide improved performance in storage and processing of data, thereby allowing data visualizations to be presented and changed more quickly than conventional solutions.

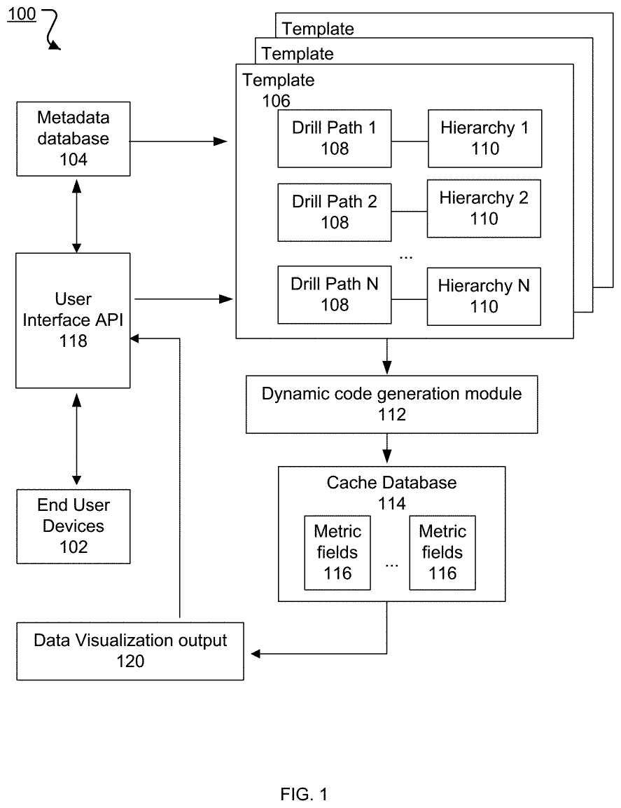

FIG. 1 illustrates an example data visualization system 100. In FIG. 1, the data visualization system 100 includes a metadata database 104, one or more templates 106, a dynamic code generation module 112, and a cache 114. These components represent a backend service in the data visualization system 100. In FIG. 1, the data visualization system also includes one or more end user devices 102, user interface API 118, and data visualization output 120. These components represent a frontend service in the data visualization system 100.

The end user devices 102 are terminals that allow users to run commands on a database for data analysis and visualization. A terminal may be a personal computer, a smartphone, a cloud cluster device, or a local server. The end user devices 102 may connect to the database remotely through a graphical user interface (GUI) that includes libraries of various operation functions in the database. User commands and output from the database may be transmitted by a content delivery network, which provides high availability and high performance by distributing the database access and service spatially relative to the end user devices 102. The network may include a local area network (LAN), a wide area network (WAN), the Internet, or other network topology. The network may be any one or combination of wired or wireless networks and may include any one or more of Ethernet, cellular telephony, Bluetooth, and Wi-Fi technologies. Communications through the network may be implemented through using Ethernet cables, a single or multiple routers or switches, or optical data links. Communications through the network may be implemented through any one or combination of various protocols, including the 802.11 family of protocols, Bluetooth, Bluetooth LE, Z-Wave, ZigBee, GSM, 3G, 4G, 5G, LTE, or other custom or standard communication protocols.

The user interface application-programming interface (API) 118 is a set of subroutine definitions and tools for end user devices 102 to communicate with a database, for example, the metadata database 104. API 118 is a defined interface through which user devices gain database system access and ingest metadata directly into a workspace for review. API 118 relates to a library for data processing, and describes or prescribes the expected data visualization output to the end user.

The metadata database 104 carries the description and context of raw data. Metadata database 104 helps the end user devices 102 to organize, search, and analyze data. Typical metadata may undertake elements including title and description, tags and categories, log history and access authority information. Some metadata may include structural information to describe the types, versions, relationships and other characteristics of digital materials, for example, how compound objects are put together. Some metadata may include administrative information to help manage a data resource, such as when and how the data was created. Some metadata may include statistical information to describe the process that collects, processes, or produces data.

The metadata database 104 may comprise a database management system for data definition, update, retrieval, and administration. For example, the database management system may insert, modify and delete the data in the database. For example, the database management system may provide data in a form that is used for further processing by other users or applications. The database management system also may register and monitor the end user devices 102 for data security. In this example, the metadata may be designated as a source field, as the metadata includes source data.

The visualization system 100 includes one or more templates 106, as shown in FIG. 1. The templates 106 includes the metadata filtering and data format rearranging information that is defined by the end user devices 102 or pre-determined in the system. Each template 106 comprises one or more drill paths 108, and each of the drill paths 108 consists of a hierarchy 110. A drill path 108 refers to a data pathway through the metadata. In data visualization, for example, the system may break the metadata into groups, rows that constitute the groups, and fields that display within the rows of the data. For this information, end user devices 102 are able to specify a label, a format, and/or whether the section will appear at any level in the drill path or only the most drilled down level. The hierarchy 110 may be in a format of a tree and include metadata group nodes that correspond to the drill path 108. There may be more than one template 106 in the data visualization system, and end user devices 102 may create a new template based on an existing one. In some implementations, only users with admin access may be able to access the templates 106 and create new templates based on data visualization requirements.

The dynamic code generation module 112 dynamically generates code in the form of stored procedures, and the stored procedures are used to build the cache. For example, the dynamic code generation module 112 may generate a routine of source code (e.g., SQL, PL/pgSQL, C, etc.) out of an application (e.g., a .NET application) using the drill paths 108 and the metadata. The dynamic code generation module 112 takes the metadata and filters out the data that is needed to generate the stored procedures for building the cache. Through dynamic code generation, the dynamic code generation module 112 uses a combination of metric fields and drill paths 108 defined in the templates 106 to automatically generate the code needed to import data and build caches that enable relatively fast access to relevant data. In this way, end users may only have to define the drill paths 108 in the templates 106 to produce useful caches of data without having to produce the specific source code needed to build the caches.

The cache database 114 includes one or more caches, which may store data in the form of metric fields 116. A cache in the database 114 supplements the primary data in the metadata database 104 by filtering out unnecessary data or reorganizing the format of the data through the data processing operations defined in one or more templates 106. The metric fields may be processed by the end user through templates for creating unique characterization of the data. The cache database 114 may be a remote database, for example, a Cosmos database, or a PostgreSQL database.

The caching may improve flexibility in the processing of data. For example, the data expected to be frequently requested and processed for visualization may be cached and saved in the cache for relatively fast retrieval. The visualization cache may provide significant performance improvements when a large number of concurrent users with similar requests are viewing the same data or metadata at approximately the same time. Instead of having to retrieve the data or metadata from the database and having to reprocess the data over and over again, the cache may provide user devices with easier access and faster visualization presentation.

The data visualization output 120 is generated based on cache data by placing the cache data in a visual context. Any patterns, trends, and correlations within the cache data may be presented with data visualization. Many diagrams may be used for data visualization, for example, a bar chart, a histogram, a scatter plot, a network image, and a streamgraph.

In some implementations, the end user devices 102 may define the reference data in the metadata and send instructions to the metadata database 104, through the user interface API 118. The user may select a metric field out of the source field data for specific data processing objectives. For example, the user may select a portion of the metadata for mean value, median value, maximum value, and minimum value calculations. The metadata may comprise various categories and some of the categories generate information for the metadata. For example, an end user may pull metric field data out based on the data resource, the data input time, or the data type. In this example, the metric field data is accessed from the cache to provide relatively fast visualization of the metrics cached in the metric field data.

In some implementations, the user may build a template to pull out the interested data as a metric field, by identifying the drill path of the data and the corresponding hierarchy. The user may build one or more templates 106 that define relevant source field data in the metadata database 104. The source field data may be converted to a metric field through the dynamic code generation and data caching processes. One or more metric fields may be stored in the cache database 114, as results of calculations performed on original source data. The data visualization output 120 may be generated from the metric fields and sent back to the user interface API 118.

In some implementations, the metadata is defined by the user in creating the template. The data visualization backend service process may read and process the template information. The backend service dynamically determines how to generate software code to build out the stored procedures to store the metric fields in the cache database. A template 106 may be used to generate one or more metric fields 116 based on user instructions used to define the template 106. The metric fields 116 may not all be retrieved at the same time, but they are stored in the cache database 114 for potential usage. For instance, a first subset of metric fields 116 may be accessed for a first visualization requested by an end user and a second, different subset of metric fields 116 may be accessed for a second visualization requested by the end user. The first subset of metric fields 116 may be completely different from the second subset of metric fields 116, or there may be some overlap in fields included in the first subset and the second subset.

In some implementations, the user may log into the system and select one or more specific templates that have been defined. These templates are associated with the user's requests for visualization of the metadata. The selected template results in use of the metric fields in the cache, instead of tracking back to metadata and repeating the data retrieval and analysis procedures again. The metric fields are then used to generate data visualization output based on the user's request and feed back to the end user devices through the user interface.

In some implementations, the user may send instructions to the cache database through the user interface API 118, and retrieve the cached data. The system may track processing of cached data when requested by end users. For instance, the cache data processing may be tracked by the system backend services as part of the system functions and used to improve cache performance.

In some implementations, the data visualization system may work for multiple end user devices that access the system from different locations. These multiple end user devices may look at the same portion of the metadata and share the same instance of the metric field in the cache. In this regard, the data visualization system does not create unique caches for each individual log in; the multiple users with the same data processing requests will all access the same cache and share the same metric fields. The system is not building new caches on the fly and thus may control memory consumption more efficiently. The system builds the metric fields 116 from the data within the metadata database 104 using the dynamic code generated by the dynamic code generation module 112. When end user data is uploaded to the system, the system identifies what template is associated with the imported data. The system then automatically builds the metric fields in the cache 114 using the dynamically generated code modules (e.g., the stored procedures). The end user devices are able to view the data from the stored metric fields in the cache, and visualize the data.

In some implementations, a user with admin access may work on a new version of the template. The user may make changes to an existing template, for example, modifying the drill path, adding new metric fields, and/or changing metric fields. The user may publish the new version of the template and the older version of the template such that previously generated cache instances are still active in the system. The existing metric fields in the cache are still reviewable within the system and refer back to the corresponding version of the template. For example, a user may import new data into the system and modify a new template version 1.1 based on an existing template version 1.0. The new data importing is based on the latest version 1.1 of the template. The metric field cache building also is based on the latest version 1.1 of the template and the user interface data visualization is different from the earlier version.

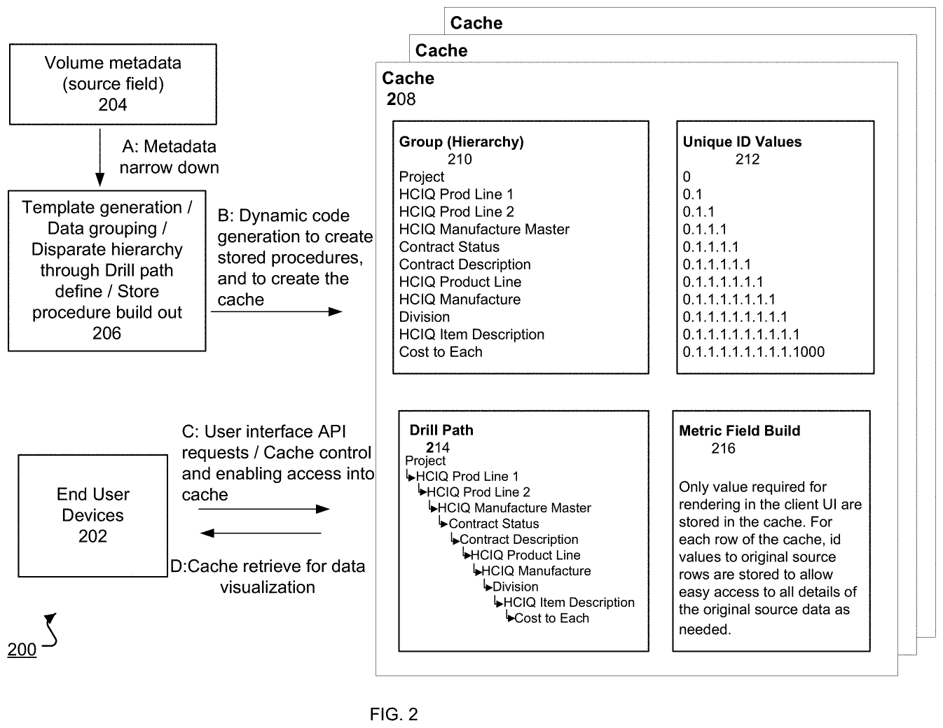

FIG. 2 illustrates example data caching operations in an example data visualization system. The data caching operations comprise procedures between various components of the data visualization systems including use of metadata source fields 204, template matching procedures 206, one or more metric fields 208, and end user devices 202.

An end user device may import a large volume of metadata 204 to the system. The metadata may be in a format of a table with millions of rows and hundreds of columns. For the data visualization, the system as well as the user interface frontend service may only need to process a subset of the metadata. As shown in step A, the first operation in this example of data caching is narrowing down the large volume of metadata.

In some implementations, an admin of the data visualization system has ability to limit access of users to the cache at an organization/user level. The first operation (step A) includes processing the metadata and determining how to visualize the metadata from a perspective of disparate hierarchies or groupings of data. The selected metadata is stored in a template of the data visualization system.

The system performs a dynamic code generation process to generate the stored procedures that are used to create cache instances and store the cache instances in a cache, as shown in step B. For example, there may be multiple metric fields that are stored in the cache and that are generated to match a selected template. The metric fields may be stored in a database on the same remote server that includes the metadata database. For dynamic code generation, the system first performs source field identification in the metadata. The system may identify necessary source fields and identify references for the metric fields. Second, the system calculates the metric fields in a defined order, as one metric field may refer to another metric field. The dynamic code (e.g., a stored procedure) calculates the metric fields being added to the cache in accordance with the drill paths defined in the templates.

The system also determines the groupings in the cache. In order to build groups in the metric fields, the program code groups and processes thousands of values in each hierarchy level. The system also determines how the groupings are built out and generates code that targets each of those hierarchy levels. The dynamic code generation is a system backend service that may be performed by, for example, a .NET application that takes the metadata and applies the metadata to build out the stored procedures that are used to build the cache.

As shown in FIG. 2, one or more caches 208 are stored in the cache database as the data caching operations results. FIG. 2 presents examples of a group hierarchy 210, values 212, a drill path 214, and a metric field build up guideline 216.

The user may determine a drill path 214 of the metadata that corresponds to a unique group hierarchy structure 210. Drill path nodes are matched to the group nodes on the hierarchy tree. The project root level is the highest level of the drill path, and the system rolls all nodes up to the project at the highest level. For example, underneath the project node, the user may select product line 1, product line 2, a manufacture master, contract status, contract description, product line, manufacture, division, item description, and cost to each as the drill path nodes. The hierarchy and dill path defines the interested metadata and groups the data to create the cache. The system processes each level and assigns distinct values for each level. The distinct values will match up to each node column in the specific category with a unique ID.

The values 212 enable users to access the data. For example, the root level project has a key of “0”. Further down the hierarchy, the first distinct value of the product line 1 may have an ID of “0.1”, and the following distinct value of the underneath level product line 2 may have an ID of “0.1.1”. In this example, a user may indicate the first product line 1 value of the hierarchy and so on down the hierarchy tree. Each level of “0” means the root level project, “1” means the first distinct value of the first level drill path. As the levels go deeper, the “item description” level may be assigned a unique ID of “0.1.1.1.1.1.1.1.1.1” and the very bottom level “cost to each” may be assigned a unique ID of “0.1.1.1.1.1.1.1.1.1.1000”. Those ID values are changing to represent a unique level of data in the cache that are saved in the cache database. The metric fields are built to distinguish various groupings. Every levels of the hierarchy gets a value and the system is able to build an ID value based on those values. Furthermore, the system is able to provide an organized cache based on the hierarchy.

The metric fields are calculated based on the narrowed down metadata, and put into the cache database. There are various types of metrics, for example, metrics created from a summarize calculation, a mean calculation, a median calculation, a minimum and/or maximum calculation, and other types of calculations. The system may roll up each level of the group by sections and then store in a unique row within the cache by their key. The ID value is associated to each of the group by fields.

The user may determine how to navigate the data visualization output, for example, a data map. The user may also be interested to see how the data is being rolled up based on a different field coming out of the original metadata. There may be multiple drill paths 214 that are defined by the user, and each of the drill paths may run the same process but on different hierarchies. For each row of the cache, the ID values of the original source rows are also stored, so it is easier for the system to get back to the original source rows that were used to generate the cache entry in the cache database.

The group hierarchy may be predetermined in the system. The predetermined hierarchy is created based on the products design and system set up. The user may have the ability to switch between different hierarchies by selecting different drill paths. The user may navigate the data visualization output, for example, a data map, from the root level to drill down the path. For example, as illustrated in FIG. 2, the user may directly check the product line 2 that is underneath the root level on the hierarchy. The user can easily switch to another similar drill path. For example, a new layer of product line 3 may be added under product line 2. In that case, the system groups by that layer and the data rolls out to each level that is above it.

As revealed in the metric field build up 216, the only values required for rendering in the user interface are stored in the cache. For each row of the cache, the ID values to source rows are stored to allow easy access to all the detailed values that are associated with the cache entry.

As shown in step C, the end user may send requests to retrieve the cached data from the cache database, through the user interface API. For example, a user may pass the cache database an ID value “0.1.1.1.1.” and the system will quickly direct the user to the entry of the cache based on the ID value. The user may request the ID values and, for only one row or certain sub level in the hierarchy, the system may retrieve one record or multiple records. The user also may drill down multiple levels of the hierarchy based on the starting position of the hierarchy.

The calculated metric fields are being stored in the cache database and retrieved for data visualization to the user end, as shown in step D. For example, the caches may be stored in a remote database server. The user may utilize the cache database features to build the hierarchy trees, which allows a quick navigation of the database table to locate the data referred to by the user. For example, the user may request to retrieve the first four levels of the hierarchy starting at the root level. So each data visualization output, e.g. a map, represents the first level of the hierarchy. The user may traverse to the lower level of the hierarchy, e.g. level 2 and level 3 for more detailed visual data outputs. The user may retrieve data down the hierarchy and get visualizations quickly, by interacting with the user interface API to conduct the operations based on the specific hierarchy in the cache database.

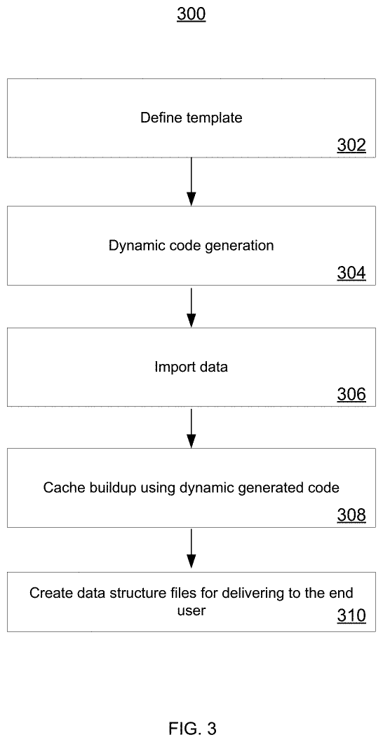

FIG. 3 illustrates an example process of data visualization operations. The process 300 is described as being performed by system 100. The process 300 also may be performed by system 200 or one or more computers or electronic devices that include processors that execute instructions.

The system 100 defines a template including one or more drill paths (302). For example, the system 100 may receive, from an end user, user input defining one or more drill paths to include in the template. In this example, the system 100 may define the template to include any information (e.g., drill paths, rules, parameters, etc.) discussed throughout this disclosure as being included in one or more templates. The end user also may create a new template for data grouping. More than one template may be used in the data visualization system, and end user devices may create a new template based on an existing one.

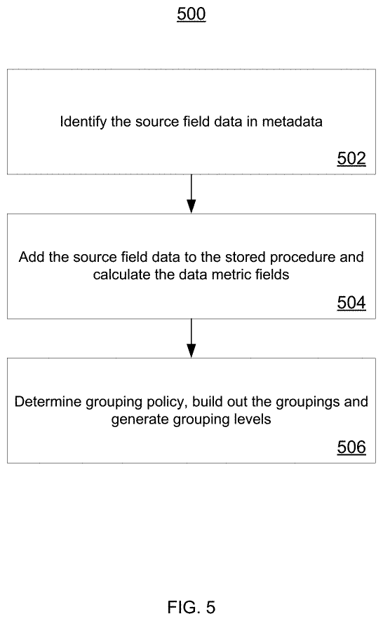

The system 100 performs dynamic code generation (304). For example, the system may use a dynamic code building service to dynamically generate stored procedures based on the defined template. This service builds separate stored procedures for each enabled drill path defined in the template. The dynamic code generation includes adding the source field data to the stored procedure and producing code needed to calculate the data metric fields 116. The calculations need to be in a correct order because one metric field may refer to another metric field. The dynamic code generation also includes determining data grouping policies, building out the groupings, and generating each of those grouping levels. Once the dynamic code is created, the code may be used to build caches for data imported to the system. The dynamic code may be reused for additional imports of source data related to the defined template. FIG. 5 provides more detailed description of dynamic code generation.

The system 100 imports data to a metadata database for a template through an automated process (306). For example, an end user may upload metadata via the template designer repository features to initiate an automated process for importing the data. In this example, the system 100 receives user input identifying source data and one or more templates associated with the source data. Based on the user input, the system 100 imports the source data automatically in accordance with the one or more templates and the dynamic code generated based on the one or more templates.

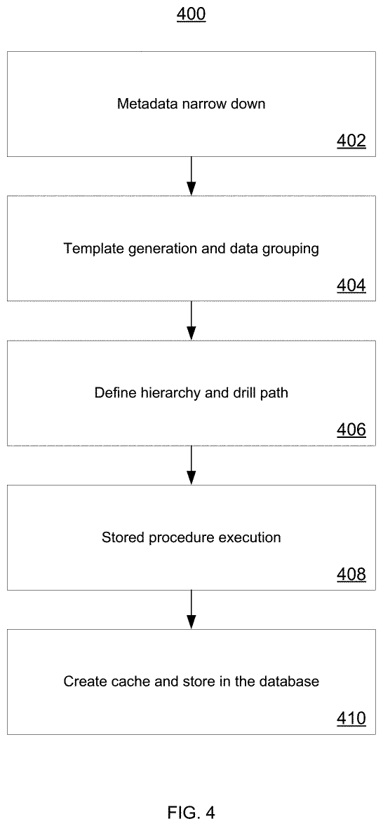

The system 100 performs cache buildup using the dynamically generated code (308). The dynamic cache buildup 308 creates metric fields from source field data stored in metadata database 104, and stores the metric fields as cache instances in the cache 114. The dynamic cache buildup 308 performs functions defined by the dynamically generated stored procedures to cache imported data using an automated process. For instance, the dynamic cache buildup 308 includes building and populating cache, for example, the PostgreSQL tables for each specified drill path in the template. FIG. 4 provides more detailed description of dynamic cache buildup.

The system 100 creates data structure files for delivery to end user devices (310). For example, the source field data may be compressed and saved as zipping files, and delivered to the end user devices through the content delivery network for data visualization. In another example, the system 100 may export the compressed source field data to the remote database server for data consumption on the end user devices 102.

FIG. 4 illustrates an example process of data caching 400. The process 400 also may be performed by system 200 or one or more computers or electronic devices that include processors that execute instructions.

The system 100 performs a narrowing down of a large set of original metadata to a smaller data set in the cache (402). For instance, metadata is imported to database 104, and metadata narrowing down 402 is conducted based on one or more templates associated with the imported data. The metadata database stores large volumes of data for customers and the end user may define a narrowed range of data for data caching.

The system 100 conducts template matching and data grouping (404). For example, the user may select an existing template for metadata processing and the system 100 group's data for the caching process in accordance with the template and the dynamic code generated for the template. A template may define metadata filtering and data format rearranging information that has been set by the end user devices or pre-determined in the system 100. Each template may comprise multiple drill paths, and each of the drill path consists of a hierarchy.

The system 100 defines disparate hierarchies of data using one or more drill paths (406). The drill path refers to a data pathway through the metadata. In data visualization, for example, the system may break the metadata into groups, rows that constitute the groups, and fields that display within the rows of the data. The end user is able to specify a label, a format, and/or whether the section will appear at any level in the data drill path or only the most drilled down level. The hierarchy may be in a format of a tree and include metadata group nodes that correspond to the drill path in a template. The user may determine the control of the cache and enable access into the cache. The user may define how to view the data from a perspective of disparate hierarchies or groupings of data. The user may define a drill path on the hierarchy from the root level to the bottom levels and include all interested intermediate nodes. Several drill paths may be defined within one template, and each drill path defines a hierarchy.

The system 100 executes one or more stored procedures to build the cache (408). The data visualization system may pass key pieces of metadata, for example, data source, metric fields, drill path for hierarchy, and group by statements. The system may take all information that has been received and conduct a process of determining the data layout and the dynamic code (e.g., stored procedures) will be used for cache buildup. In general, a stored procedure has been built for each drill path. The system 100 identifies the one or more stored procedures that were previously dynamically generated for the one or more templates associated with the imported data, and initiates execution of the identified stored procedures.

The system 100 creates the cache using the stored procedures and stores the cache in the cache database (410). The system backend uses database management functions, for example, SQL, PL/pgSQL or C within the dynamically generated stored procedures to process the metadata to build the cache. The cache, including metric fields, is stored in a database. For example, the cache may be stored in a remote database. The system 100 generates data visualization output based on cache data and places the cache data in a visual context on the end user devices 102. Any patterns, trends, and correlations within the cached data can be exposed and recognized easier with data visualization. There are many diagrams that can be used for data visualization, for example, a bar chart, a histogram, a scatter plot, a scatter plot, a network image, and a streamgraph.

FIG. 5 illustrates an example process of dynamic code generation. The dynamic code generation process 500 performs, in a dynamic manner, software code programming to generate the stored procedures used to create the cached data for each drill path. In general, the dynamic code generation process includes identifying the source field data in the metadata. The dynamic code generation process includes adding the source field data to the stored procedure and calculating the data metric fields. The dynamic code generation process includes determining data grouping policy, building out the groupings, and generating each grouping level. The process 500 is described as being performed by system 100. The process 500 also may be performed by system 200 or one or more computers or electronic devices that include processors that execute instructions.

The system 100 identifies the source field data in the metadata (502). The end user may not need all metadata and the system 100 determines what source field data is needed for the data visualization. The end user may control the order of the grouping until the process goes back up to the very beginning of the template. The system may also check what source field is referred to by a metric field.

Once the drill path and data hierarchy are defined, the system 100 further adds the source field data to the stored procedure and calculates the data metric fields (504). The user may operate the system to calculate the metric fields. The calculations need to be in a correct order because one metric field may refer to another metric field. The system has to make sure the code is setup and adds the field to the stored procedure in a correct place.

The system 100 also determines data-grouping policy, builds out the groupings, and generates each grouping level (506). The end user may look at the groupings in output-visualized figures and figure out how to build out the groupings where thousands of values in each needed level may be rolled up. The system 100 builds the groups out and stores the calculated roll up values to the highest level of the hierarchy, and calculates more roll up values to the next level down and so on so forth.

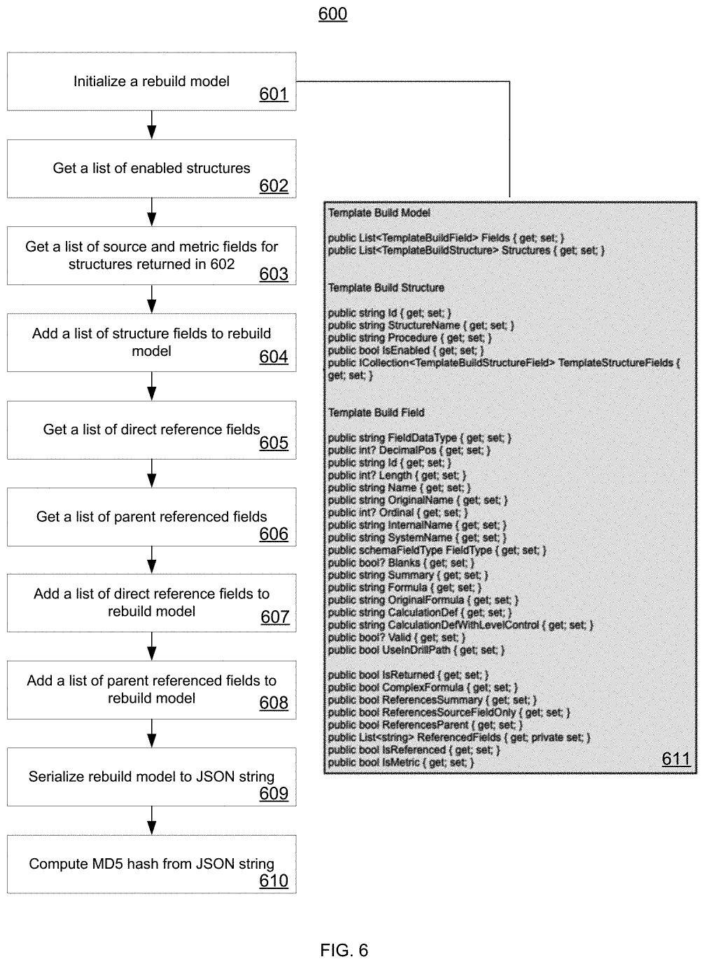

As described earlier, the present disclosure allows the end user to rebuild the template and manage the cache in the data visualization system. FIG. 6 illustrates an example flow diagram of template rebuild validation. The process 600 is described as being performed by the system 100. The process 600 also may be performed by system 200 or one or more computers or electronic devices that include processors that execute instructions.

The system 100 initializes a template rebuild model (601). For example, the system 100 may determine that a user input change triggers a template rebuild. The user input may be a change to the template that requires a change in the metric calculations or a change in the drill path that necessitates a rebuild of the stored procedures and the cache that supports the template. Based on the determination, the system 100 initializes the rebuild model of the template. The initialization of the rebuild model may include initialization of the template build structures and the template build fields, as shown in 611 of FIG. 6.

The system 100 then gets a list of enabled build structures from the template (602). For example, the system 100 checks whether or not the IsEnabled element of the drill path is true.

In the following procedures for template rebuild validation, the system 100 collects a list of enabled structures (602) and a list of source and metric fields (603), adds a list of structure fields to rebuild the model (604), and collects a list of direct reference fields (605) and a list of parent referenced fields (606), sequentially as shown in FIG. 6. Additionally, the system 100 further adds a list of direct reference fields to rebuild the model (607) and adds a list of parent referenced fields to rebuild the model (608). The direct reference fields are fields that are referenced within the template, for example in a calculation for a metric field or used in a color, a size, a grid or a scorecard. The parent reference fields may be fields that are referenced from other fields. In some implementations, the sequence of getting the list of structures and fields from procedures 602 to 608 may be varied.

Once the required structure information and field information is collected, the system 100 serializes the rebuild model to JSON objects (609). The JSON objects may include compositions of numbers, strings, lists, and dictionaries. Finally, a hash, for example, a MD5 hash, is computed from the JSON objects (610) and later compared with a hash that was stored in the template during a previous operation to determine the template rebuild. The hash is stored in the template and configured to store all key components that are used to generate stored procedures for the template.

In the present disclosure, the end user or users with admin access can adjust the template inputs and view the changes immediately through a preview in the data visualization system. The preview provides a function of letting end users preview consequences of the template adjustments or changes before committing the changes. The preview may be shown in various forms, e.g., a map, a chart, or a table. Because the template adjustment may change the structure of the template, as a result, it may force a template rebuild per the preview. A template rebuild for a preview may relate to whether the inputs modify hash components of the template throughout entire interactions with the template. In cases that the input changes do not force a rebuild of the template, the adjusted template can be shown immediately in the preview.

In some implementations, the preview may be outdated and need to be rebuilt in responding to the template adjustments. The changes made to the template are being tracked in order to reduce the redundancy for updating the template. For example, it may be determined that the changes made to the template are important and thus force a complete rebuild of the template for the preview. In other examples, the changes made to the template are determined to be less important, therefore the template rebuild is not forced and the preview can be viewed immediately.

The system 100 utilizes a hashing algorithm that stores key components of the template as hash values and triggers the template rebuild by comparing the hash values generated between current and previous operations. Generally, the hash values are created and stored within the template, to track iteration of key components that are used in generating the stored procedures. During a validating procedure of the template rebuild, all areas of the template are checked to generate the hash values.

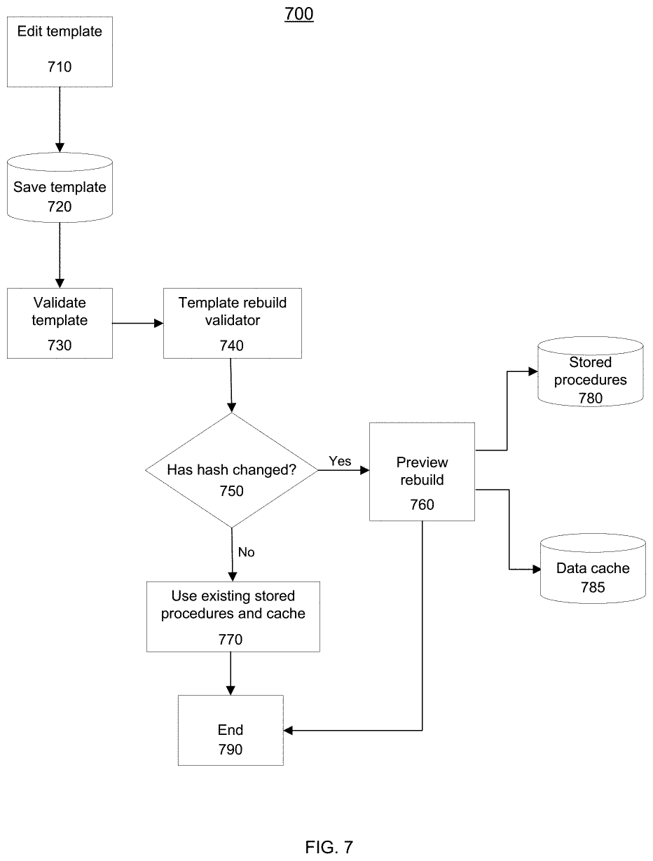

FIG. 7 illustrates an example flow diagram of enhanced template validation. The template validation, determined by a template rebuild validator (740), is triggered once template adjustments from an end user are saved (710 and 720).

Generally, when the template is adjusted, a validation process across the template is needed before generating the preview (730). A result of the validation process will notify whether a rebuild of the template is needed or not. The validation process performed by the template rebuild validator may determine whether or not the hash has changed (750) and, as a result, whether the rebuild of the preview (760) is needed. Once the hash is determined to have been changed, the preview becomes obsolete and the template will be rebuilt before generating the preview. This instance will also trigger building new stored procedures (780) and data cache (785). If the rebuild of the preview is determined to be not needed, the validation process ends (790). Alternatively, the validation process may determine that the template rebuild is not needed, therefore the preview is re-enabled from the previous operation and the template is ready without rebuilding the stored procedures, functions, and cache. In this case, the system 100 will utilize the existing stored procedures and cache for operations (770).

The determination of the template rebuild validator is based on a comparison of the hash values that are generated from a present operation, e.g., the template adjustment, and hash values that are stored in the previous operation of generating stored procedures.

If the hash values generated based on the template adjustment matches to the hash values stored or described in the template, then no key components of the template have been changed and the system 100 is able to preview immediately without going through the template rebuilding and regeneration of the cache. If not, the saving of the template adjustment triggers the template rebuild, and building of new stored procedures and cache. This hashing algorithm, as described in FIG. 7, may improve the efficiency of new template design or template adjustment.

In some implementations, a new drill path is being created in the template and arranged in a certain relevance to an existing drill path. If only the order of the drill path is modified, for example, being moved up and down, then this adjustment does not change key components of the template and maintains a same drill path structure. The only difference is that the drill path is moved up and down in the view of end user device. Similarly, this template adjustment will not create new hash values in the template and would not force template rebuild or regeneration of the cache.

In some other implementations, a field of the drill path may be edited or deleted. This type of adjustment will change at least the unique ID values of the fields in the templates and thus change the calculated new hash values. In this case, the template adjustment will force a template rebuild for the preview and regeneration of the cache.

There are a plurality of user input changes that may force the rebuild of the template and that can be identified through the validation process. For example, changing of the data source will force the rebuild of the template. The changing of data source includes changing a name of a field that is being used elsewhere, changing a datatype when the field is used elsewhere, changing an expression for calculated column values used in the template, changing a summary value for the calculated column values used in the template, and changing of blanks as zero for the calculated column values used in the template. In particular, changing of the drill path may force the rebuild of the template. The changing of drill path includes deleting the drill path, changing an order of the drill path, changing the drill path to a different group, setting the drill path as disabled, and modifying a field in the drill path. In another example, the changing of data appearance on the end user devices, e.g., at least one of a color, a size, a sort, a grid, a scorecard, or a dashboard, may force the rebuild of the template, wherein the color, the size, the sort, the grid, the scorecard, and the dashboard are included in a calculated field that was not previously included in the template.

The system 100 may include a validation API configured to verify all user inputs and make sure no issues of designing the template, generating the dynamic code, and building the cache exist. For example, when an end user input is saved for a template, the validating API will check through all the key components in the template and verify whether the input will cause any issue in building the template and generating the cache.

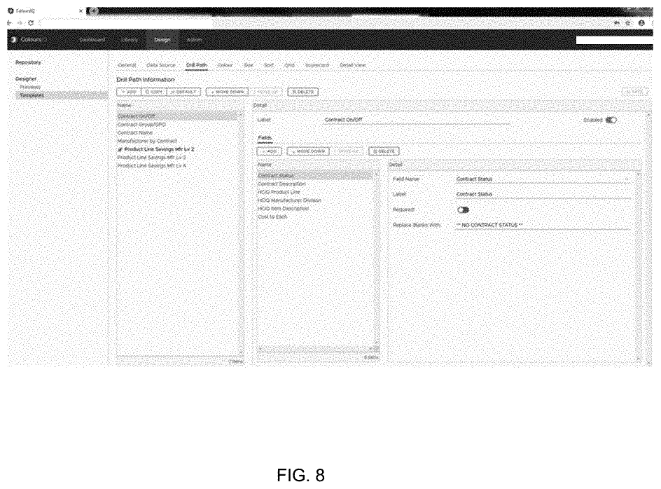

FIG. 8 illustrates an example of an advanced designer module for dynamically defining a data visualization. While ingesting data in any format, the user may use the advanced “Designer” module of the system to dynamically define how the data will be visually displayed to any end consumers of the application. All metadata defining the visual experience is attached to a template in the database. During the process of building a template using the advanced “Designer” module, proprietary streamlined software is created for the template and each drill path within the template for rendering to the end user. The data visualization system dynamically builds software on the fly to enhance the end user experience and provide more scalability.

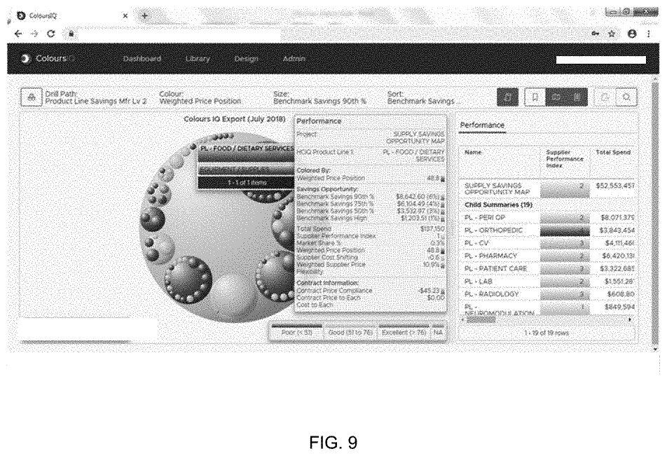

FIG. 9 illustrates an example of a graphic data tool that allows users to view data in multiple levels deeper from a summary level. The dynamically built software may process millions of rows of data creating a proprietary caching process for each drill path. The cached data is shared amongst all users accessing the application provided they have the required level of authorization. A complete data set, regardless of size, is represented in one visual image. The user may easily see up to five levels deep from summary level starting point. No other graphic data tools allow this ability to see “inside” the data to this degree at one time.

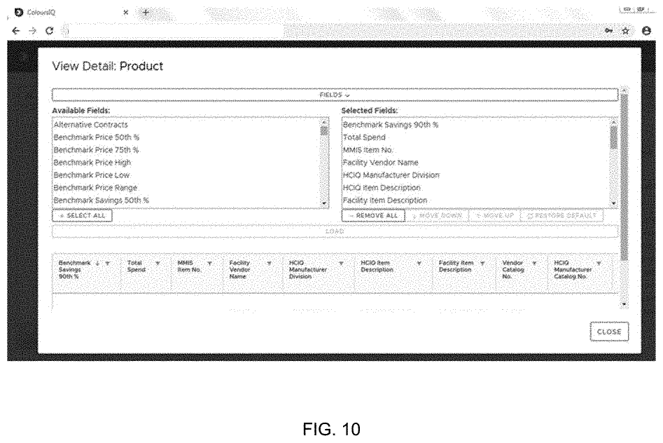

FIG. 10 illustrates an example of a dynamically created customizable callout feature. In the system, deep analytics are performed for hundreds of levels within seconds. The user is visually guided from the highest-level opportunity to a single item opportunity within seconds. This feature enables the system 100 to quickly retrieve associated data through use of the source field rows stored in the cache. By using the dynamically created customizable callout feature, the user can connect any group of items or single item to any type of content, e.g. application, file, internet location, intranet location, media file, educational content, product recall content, etc.

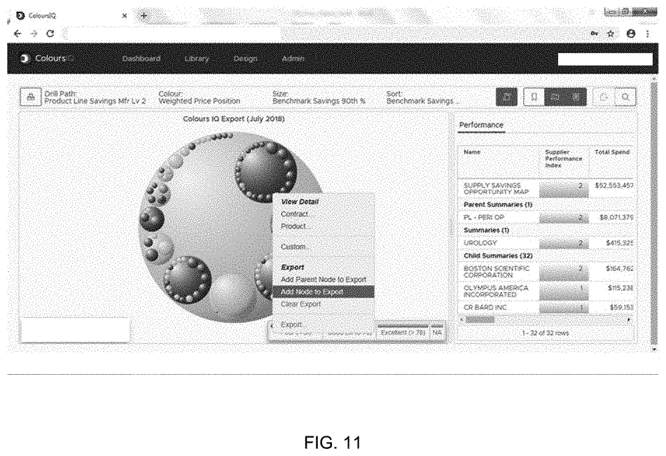

FIG. 11 illustrates an example of viewing and exporting a node's data. The data visualization system allows users to view data from multiple data systems on one platform. Seeing the software information system, the Materials Management information system, the Electronic Medical Record, Financial and Patient Accounting data all in one common view, allows the user to see relationships between clinical behaviors and outcomes. The user can also view and export a node's data behind the visual image. A user does not have to be an expert in another software tool, for example, Microsoft Excel. The user can group and sort the data within the tool.

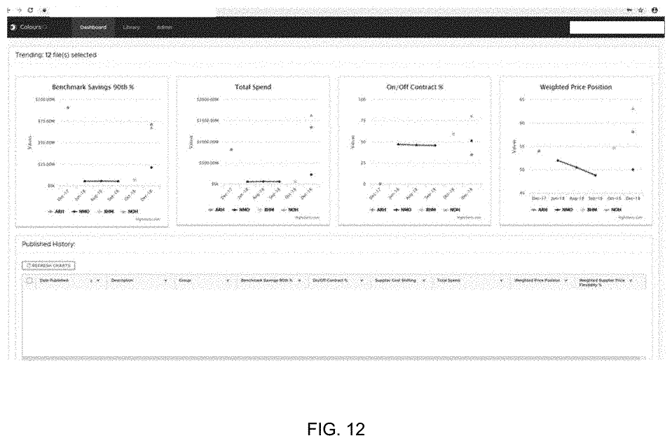

FIG. 12 illustrates an example of one or more underlying proprietary cached datasets to render a dashboard illustration of one or more trends. This system has the ability to combine multiple data sets into one customized view that leverages the simple visual navigation. The latest version of the software uses the underlying proprietary cached datasets to render a dashboard illustrating trends across pre-selected datasets. Without the underlying proprietary caching techniques, rendering Big Data like this would not be possible.

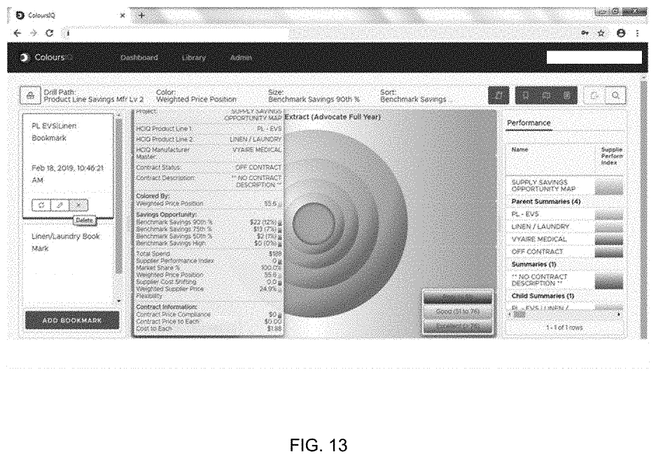

FIG. 13 illustrates an example of a bookmark for data visualization. Bookmarks can be created at any level in the map or dataset and be used to navigate back to the visual location for the bookmark. A user can also mouse over the bookmarks to get a quick picture of the scorecard for the node at the bookmark's location.

This disclosure includes a user interface tool as the strategic framework. The software tool performs as the visual language of the data and conducts functions that include: Simplifying the understanding of Big Data, increasing the collaboration of all stakeholders, supporting or refuting ideas using Big Data at the Speed of the Conversation, and measuring and documenting results of projects. The software tool is an effective collaboration and documentation tool in the four phases of a project that include: 1) Discovery of opportunities and anomalies, 2) Strategy development, 3) Project implementation, and 4) Documented measurement and results of project.

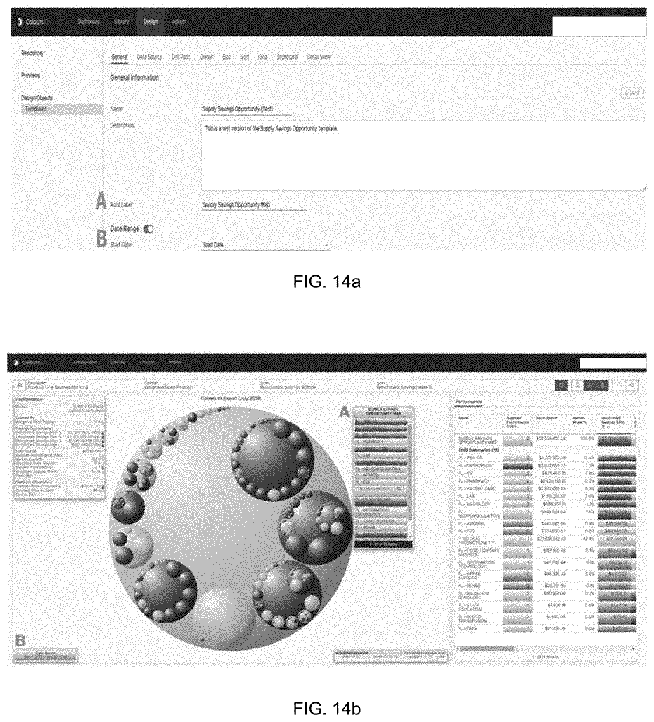

The Design module of the software tool allows a user to create or modify a template for data, setting the labels and rules that dynamically drive the creation of the software used to build the underlying cache and render the view of the map. FIGS. 14a to 23c outline the various options that a user has in the design section that directly influences the rendering of the map as well as how the underlying software is created.

FIGS. 14a and 14b illustrate an example of a general tab for data visualization. On this tab, a designer or user can set the following content including: 1) name of the template, 2) description of the template, 3) root Label (‘A’ in FIGS. 14a and 14b) which refers to the very top level of the map, and 4) the start and end dates (‘B’ in FIGS. 14a and 14b) which shows the date range of the data while in the map view.

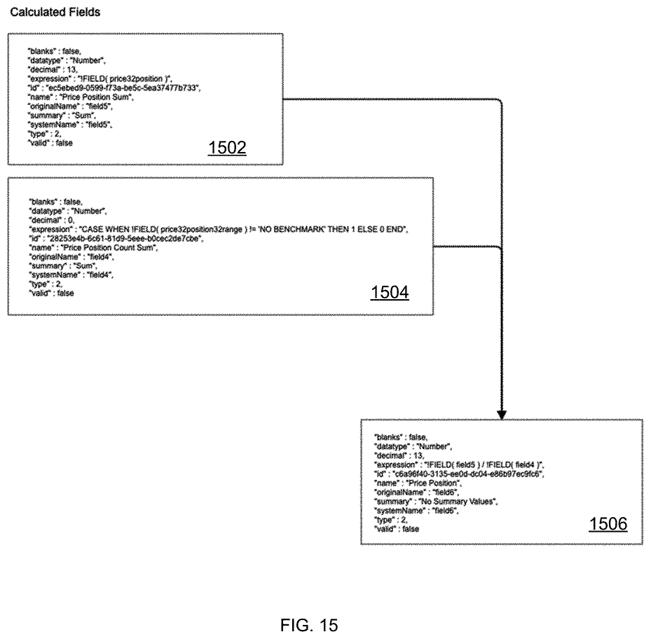

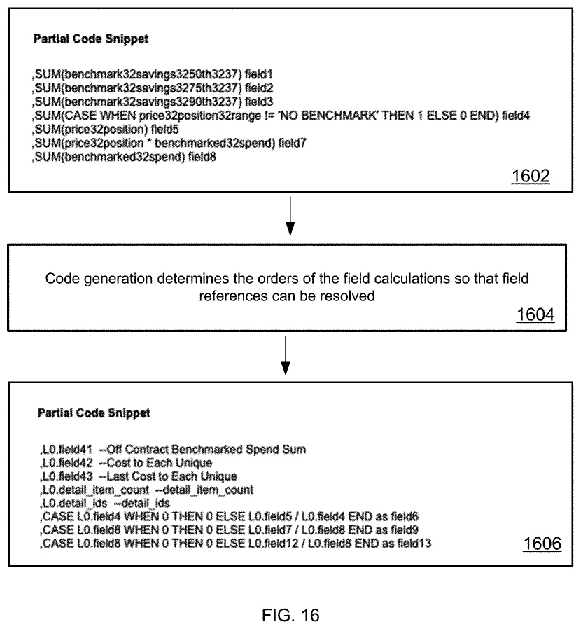

FIG. 15 illustrates an example of software code that is stored in a remote database and used to modify the attributes of the data source fields. The Data Source tab is used to create and configure the fields that factor into all of the other sections of the template. The changes made here cannot be directly seen in the map view. In this function, a designer can conduct operations on editing attributes of Data Source Fields. This option is available for original Data Source columns include changing the datatype and decimal places for a Field. A designer can also conduct operations for creating calculated columns. This option allows the designer to create calculated columns and modify datatypes, including modification of decimal places, expressions, how they are summarized, and whether or not to treat a blank value as a zero. FIG. 15 gives an example of the JavaScript Object Notation (JSON) code that is stored in the Cosmos database to dynamically generate stored procedures. FIG. 16 gives an example of software code that is stored in the remote database used to dynamically generate a metric field.

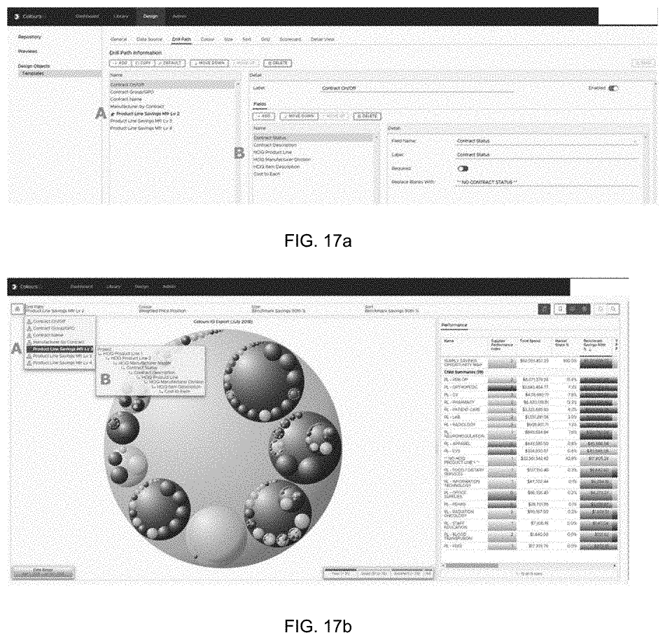

FIGS. 17a and 17b illustrate an example of a drill path tab for data visualization. On this tab, a designer can set the following content including a drill path (‘A’ in FIGS. 17a and 17b) which refers to the pathway through the data. Columns are organized hierarchically. Different Drill Paths can be created, each of which have their own fields belonging to them. A user can also specify a default drill path, meaning the first drill path to display upon opening a map of this Template type. A designer can also set the following content including the fields (‘B’ in FIGS. 17a and 17b). The fields corresponds to how the data is organized hierarchically. Fields can be given labels or sets as required. If a field is required, then it will not display in the map if it does not have a value.

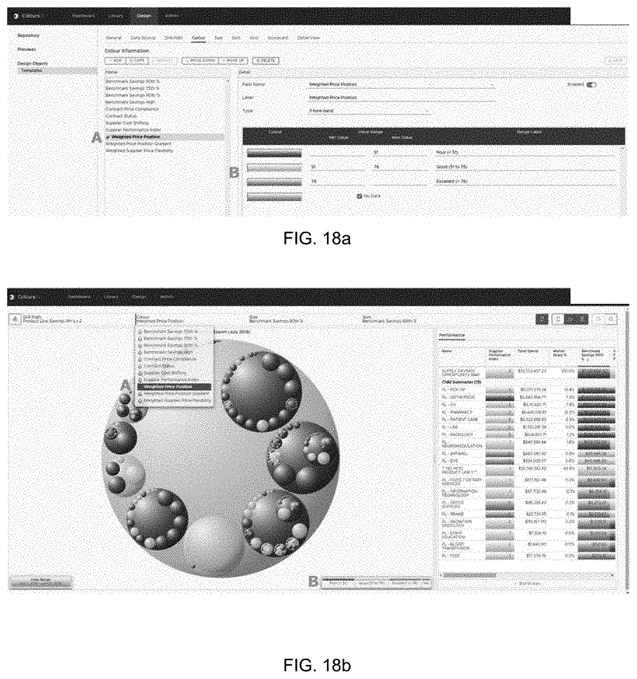

FIGS. 18a and 18b illustrate an example of a color tab for data visualization. On this tab, a designer can set the color scheme (‘A’ in FIGS. 18a and 18b). These schemes exist to visually guide a user through the data. Any calculated column can be used to create a color scheme. A user can also specify a default color scheme, meaning the first color scheme to display upon opening a map of this template type. A designer can also set the color ranges (‘B’ in FIGS. 18a and 18b)—These are the rules that determine how calculated values are colored. Here a designer can specify the exact conditions for how nodes are colored. The designer can specify to use solid colors for each condition or color gradients as values get closer or further from particular rules. The designer can also specify whether or not to apply color to nodes where the metric used to color the node does not exist at a point in the drill path.

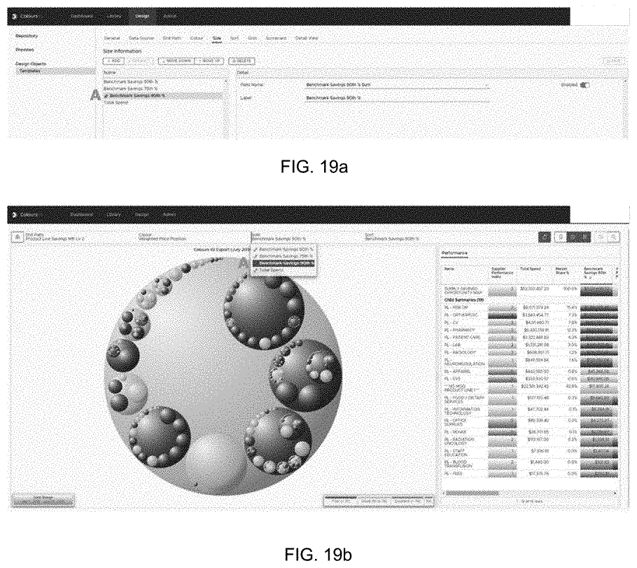

FIGS. 19a and 19b illustrate an example of a size tab for data visualization. On this tab, a designer can set the size scheme (‘A’ in FIGS. 19a and 19b). This refers to how large each node appears in relation to the others. Different size schemes can be created, each of which have their own field belonging to them. A user can also specify a default size scheme, meaning the first size scheme to display upon opening a map of this template type.

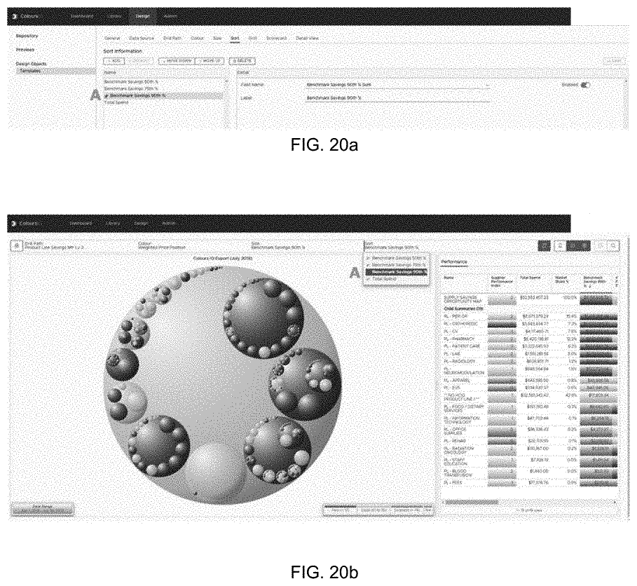

FIGS. 20a and 20b illustrate an example of a sort tab for data visualization. On this tab, a designer can set the sort scheme (‘A’ in FIGS. 20a and 20b) which refers to the order in which each node in the map is arranged in relation to the others. Different sort schemes can be created, each of which have their own field belonging to them. A user can also specify a default sort scheme, meaning the first sort scheme to display upon opening a map of this Template type.

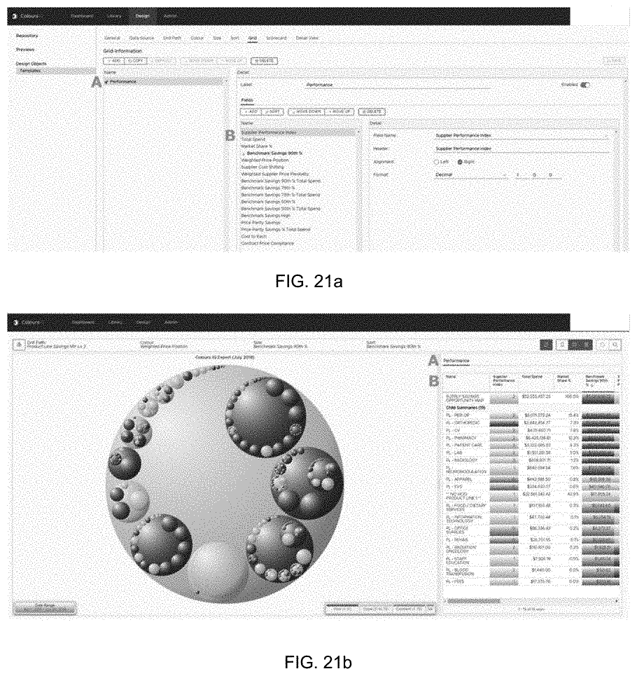

FIGS. 21a and 21b illustrate an example of a grid tab for data visualization. On this tab, a designer can set the grid sheet (‘A’ in FIGS. 21a and 21b). The grid is a section that appears to the right of the map where a table of columns is displayed including metric related to the current drill path. Different grid sheets can be created, each of which have their own fields belonging to them. A designer can also specify a default grid sheet, meaning the first grid sheet to display upon opening a map of this template type. A designer can also set fields (‘B’ in FIGS. 21a and 21b). These are the fields that make up the grid sheet. The designer can specify which fields are shown, what header is displayed for them, how they are aligned in the grid sheet, the field's format, and which field is used to sort the grid sheet.

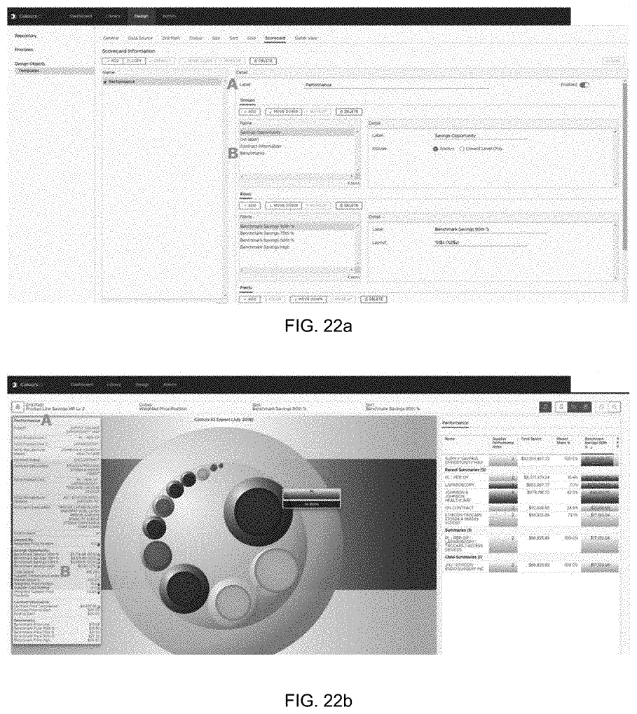

FIGS. 22a and 22b illustrate an example of a scorecard tab for data visualization. On this tab, a designer can set the scorecard (‘A’ in FIGS. 22a and 22b). The Scorecard is a section that appears while hovering over a node in the map where key metric are displayed related to the current drill path. This is a more focused, concise view than the grid. A designer can also set the groups, rows, and fields (‘B’ in FIGS. 22a and 22b). The scorecard can be broken into groups, the rows that constitute those groups, and the fields that display within the rows. For all of these, the designer is able to specify a label, the format, and whether the section will appear at any level in the drill path or only the most-drilled-down level.

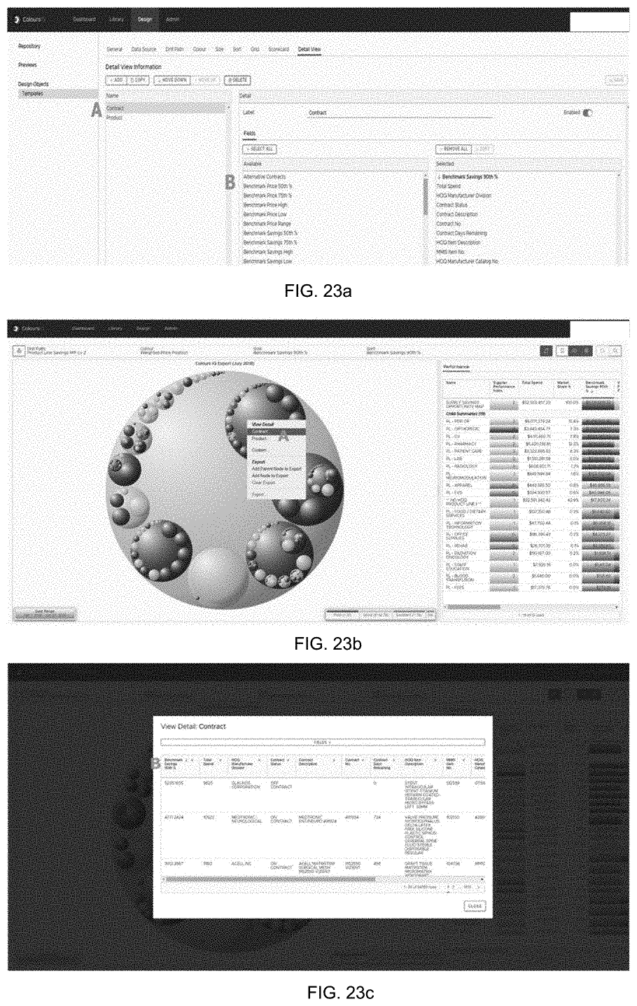

FIGS. 23a, 23b and 23c illustrate an example of a detail view tab for data visualization. On this tab, a designer can set the detail view (‘A’ in FIGS. 23a and 23b). The Detail View is a way for a user to return data elements that may not be found in the drill path, grid, or scorecard, particularly qualitative information like ID numbers or descriptions. This section appears when a user right-clicks in a node in the map. Different detail views can be created, each of which have their own fields belonging to them. A designer can also set the fields (‘B’ in FIGS. 23a and 23c). These are the fields that make up the detail view. The designer can specify which fields are shown and which field is used to sort the grid sheet.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A method for data visualization comprising:
defining a template that includes one or more drill paths for data visualization;
performing dynamic code generation to build at least one stored procedure for the one or more drill paths, the dynamic code generation comprising generating dynamic code used to calculate data metric fields for the one or more drill paths included in the defined template;
importing, based on user input, the defined template, and the at least one stored procedure, source data that is needed to calculate the data metric fields using the generated dynamic code;
caching, in a cache and based on the generated dynamic code, the imported source data and the data metric fields calculated using the generated dynamic code; and
generating, based on the cache data, at least one data structure as data visualization output for one or more user devices, the at least one data structure enabling data visualization of the one or more drill paths included in the defined template.

2. The method of claim 1, further comprising:
gaining, through a user interface application-programming interface (API), source data access; and
ingesting, using the user interface API, the source data directly into a workspace for review,
wherein the user interface API relates to a library for data processing and enables a data visualization output to the one or more user devices.

3. The method of claim 2, wherein importing the source data comprises:
storing the source data to a database;
modifying the stored source data to a form used for data processing by other users or applications; and
registering and monitoring the one or more user devices for data security of the stored source data.

4. The method of claim 1,
wherein the one or more drill paths refer to data pathways through the source data,
wherein the source data is broken into groups, rows that constitute each of the groups, and fields that display within each of the rows, and
wherein the at least one data structure specifies a label, a format, and whether the source data appears at any level of the one or more drill paths or only a most drilled down level of the one or more drill paths.

5. The method of claim 2, further comprising:
defining reference data in the database; and
sending instructions to the database through the user interface API,
wherein one data metric field is selected from the source data for a specific data processing objective based on the instructions sent to the database through the user interface API.

6. The method of claim 1, wherein the data caching comprises:
narrowing the imported source data to cache data stored in the cache, the imported source data has a larger size than the cache data stored in the cache;
selecting the template to define data filtering and data format rearranging information;
defining disparate data hierarchies by using the one or more drill paths, wherein each of the one or more drill paths defines a hierarchy of data;
receiving source data information to determine source data layout and the generated dynamic code used for caching; and
building, based on the at least one stored procedure and by using a data management function, the cache.

7. The method of claim 6, wherein the hierarchy of data is in a format of a data tree and includes source data group nodes that correspond to the one or more drill paths.

8. The method of claim 6, wherein one or more caches are stored in the cache, the cache storing data in form of metric fields, and
wherein the cache is a remote database.

9. The method of claim 6, wherein the dynamic code generation comprises:
identifying the source data for the data visualization;
calculating, based on the identified source data and the at least one stored procedure, the data metric fields;
determining data grouping policy; and
creating, based on the calculated data metric fields and determined data grouping policy, dynamic code to build cache data.

10. The method of claim 6, wherein the source data information comprises data source, metric fields, drill path for hierarchy, and groupby statements.

11. The method of claim 6, wherein, based on narrowed down source data, the metric fields are calculated from at least one of a summarize calculation, a mean calculation, a median calculation, a minimum calculation, or a maximum calculation.

12. The method of claim 1, further comprising:
processing a plurality of caches respectively for the one or more drill paths;
sharing the data visualization output among the one or more user devices; and
presenting, by a graphic data tool, visualization data in multiple levels that drill down from a summary level.

13. The method of claim 1, further comprising:
combining multiple data visualization outputs into one customized visualization view that leverages a visual navigation; and
rendering a dashboard illustrating trends across pre-selected datasets by using underlying cached datasets.

14. The method of claim 1, further comprising rebuilding, based on template adjustment, the template for a preview in the data visualization output.

15. The method of claim 14, further comprising template rebuild validation including:
initializing a rebuild model of the template;
receiving a list of enabled structures of the template;
receiving a list of a plurality of fields including source and metric fields, structure fields of the rebuild model, direct reference fields to the rebuild model, and parent reference fields to the rebuild model; and
serialize the rebuild model to JSON objects to compute a new hash for the template.

16. The method of claim 15, wherein the template rebuild is determined based on a comparison of hash values that are generated from the template adjustment and that are stored over time.

17. The method of claim 16, wherein:
based on the hash values generated from the template adjustment matching the hash values stored in the template, providing the data visualization output to show a preview without rebuilding the template or generating the cache, and
based on the hash values generated from the template adjustment being different from the hash values stored in the template, rebuilding the template before the preview by regenerating the at least one stored procedure and the cache.

18. The method of claim 14, wherein the template adjustment includes:
changing of data source including changing a name of a field that is being used elsewhere, changing a datatype when the field is used elsewhere, changing an expression for calculated column values used in the template, and changing a summary value for the calculated column values used in the template; and
changing of appearance of the source data in the data visualization output including a color, a size, a sort, a grid, a scorecard, or a dashboard.

19. The method of claim 2, further comprising:
verifying, by a validation API, user input to avoid issues involved in designing the template, generating the dynamic code, and building the cache.

20. The method of claim 1, further comprising:
performing, by a user interface tool, a visualization of the source data and the calculated metric fields using the at least one data structure.
